(19) United States
(12) Patent Application Publication
(10) Pub. No.: US 2026/0057072 A1
(43) Pub. Date: Feb. 26, 2026

(54) PRECOMPUTING FILE HASHES FOR MALWARE IDENTIFICATION

(71) Applicant: Rubrik, Inc., Palo Alto, CA (US)

(72) Inventors: Shivanshu Agrawal, Sunnyvale, CA (US); Dhananjay Mantri, Mountain View, CA (US); Aaron Chen, Cupertino, CA (US); Chet Edward Koziol, Pleasanton, CA (US); Gregory Robert Johnston, Mountain View, CA (US); Ishaan Sang, Mountain View, CA (US); Kunal Sean Munshani, Fremont, CA (US); Joshua Jamie Stenhouse, Boston, MA (US); Kelvin Kwan, San Mateo, CA (US); Janson Chiu, Millbrae, CA (US)

(21) Appl. No.: 18/812,883

(22) Filed: Aug. 22, 2024

(51) Int. Cl. G06F 21/56; G06F 21/62

(52) U.S. Cl. CPC G06F 21/565; G06F 21/6218

(57) ABSTRACT

Methods, systems, and devices for data management are described. The method may include obtaining a first backup of a host data store in a host environment, the first backup containing a set of multiple files from the host data store, generating, for one or more files of the set, a respective hash value using content of a respective file of the one or more files, storing the respective hash value for the one or more files of the set of multiple files in a database in association with metadata for the respective file, where the database is indexed based on hash values, querying the database for a hash value generated based on content of a compromised file, and identifying, in response to querying, a latest backup of the host data store of the host environment that does not contain the hash value for the compromised file.

### FIELD OF TECHNOLOGY

The present disclosure relates generally to data management, including techniques for precomputing file hashes for malware identification.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, filesystems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports precomputing file hashes for malware identification in accordance with aspects of the present disclosure.

FIG. 2 shows an example of a computing environment that supports precomputing file hashes for malware identification in accordance with aspects of the present disclosure.

FIG. 3 shows an example of a process flow that supports precomputing file hashes for malware identification in accordance with aspects of the present disclosure.

FIG. 4 shows an example of a process flow that supports precomputing file hashes for malware identification in accordance with aspects of the present disclosure.

FIG. 5 shows an example of a process flow that supports precomputing file hashes for malware identification in accordance with aspects of the present disclosure.

FIG. 6 shows a block diagram of an apparatus that supports precomputing file hashes for malware identification in accordance with aspects of the present disclosure.

FIG. 7 shows a block diagram of a backup manager that supports precomputing file hashes for malware identification in accordance with aspects of the present disclosure.

FIG. 8 shows a diagram of a system including a device that supports precomputing file hashes for malware identification in accordance with aspects of the present disclosure.

FIGS. 9 through 11 show flowcharts illustrating methods that support precomputing file hashes for malware identification in accordance with aspects of the present disclosure.

### DETAILED DESCRIPTION

Modern businesses may leverage countless data repositories in various host computing environments. These repositories may store critical information that ranges from trade secrets to customer data. As essential as these stores are for business functions, they also present attractive targets to cyber criminals, making them susceptible to cybersecurity incidents such as ransomware attacks. Thus, while organizations endeavor to amass and utilize vast amounts of data, the organizations are likewise exposed to risk, such as data loss or data theft. Organizations may implement techniques to prevent these risks as well as efficient strategies for recovery, should these cybersecurity incidents occur.

Reducing the time for recovery following a cybersecurity incident is vital to lessen the impact on operations and financial losses. A key aspect of recovery is identifying a location and time at which the cybersecurity threat was introduced into a system. Traditional methods may include full scans of backups, where scanning includes hashing individual files and comparing the resulting hash value to a hash value of a malicious file. However, servers may store upwards of 220,000 files, and each system may have multiple servers such that billions of files are scanned as part of the threat identification process, a task that can extend over several days, weeks, or even months.

Rather than scanning files and computing hashes in response to a threat, techniques described herein support proactively generating hash values for individual files during backup or in response to generation of each backup. The hash values for each file are then stored in a “pre-hash” database is association with file metadata. During a recovery operation, the pre-hash database is queried, using a hash of the malicious file, to identify a location (e.g., backup) where the malicious file was introduced to the system. A filesystem metadata index may then be referenced to identify all the snapshots that include the same file. This technique may reduce the threat identification process to second/minutes. After identifying the relevant information, the backups containing the ransomware may be quarantined and a most recent backup that does not contain the hashes may be used for recovery. These and other techniques are described in further detail with respect to the figures.

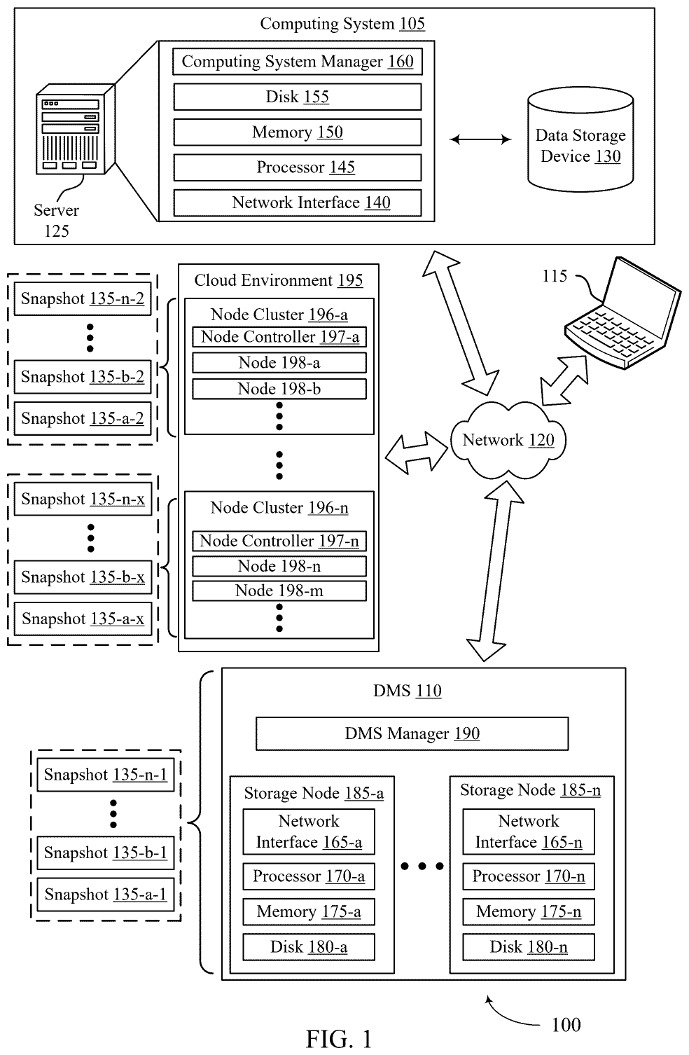

FIG. 1 illustrates an example of a computing environment 100 that supports precomputing file hashes for malware identification in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructureas-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described herein.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

As described herein, the DMS 110, the cloud environment 195, or both may facilitate backup and recovery of host computing environments, such as the computing system 105. For example, the DMS 110 obtains (e.g., receives or generates) backups of the data storage device 130 (e.g., host data store) of the computing system 105. The data storage device 130 may store various types of files including executable files. In cases where the computing system 105 is subject to a cybersecurity incident (e.g., ransomware), one or more files of the data storage device 130 may be impacted. Some backup systems may scan backups of the data storage device 130 after the cybersecurity threat is identified, where scanning including hashing files included in the backup and comparing the hash to a hash of the malicious or corrupted file. However, as the data storage device 130 and associated devices may store many files (e.g., upwards of 220,00 files per device), scanning backups to identify when and where a threat was introduced may extend over many days, weeks, or months.

According to techniques described herein, the DMS 110 may hash files of backups when (e.g., after, in response to) the backups are obtained (e.g., generated by the DMS 110 or received from the computing system 105). The hash values for files of a backup may be stored in a database (e.g., storage nodes 185, node clusters 196) that is indexed based on the hash value to support efficient hash value lookup. The DMS 110 may also maintain a filesystem metadata index that includes a mapping of files (e.g., file paths) to backups (e.g., backup identifiers) where the file is present, along with other metadata such as the file modification time in each backup.

To identify locations of malicious files in the host system, the DMS 110 may query the database for hash values matching hash values of one or more malicious files. The querying may result in the identification of the backup in which a file was added or changed. Thus, after identifying the backup where the file was introduced, the DMS 110 may reference the filesystem metadata index to identify additional backups where the file with the corresponding version is present. These backups may then be quarantined and/or backups not containing the malicious file may be used to recover the data storage device 130. Thus, rather than scanning multiple backups for multiple systems after a threat is identified, the techniques described herein support the DMS 110 querying a database with previously generated hashes to identify a backup location of a malicious file, and the database is configured to support efficient querying and backup identification. Thus, threat location identification may be reduced to seconds or minutes relative to the extended post threat identification scanning (hash generation) used by other systems.

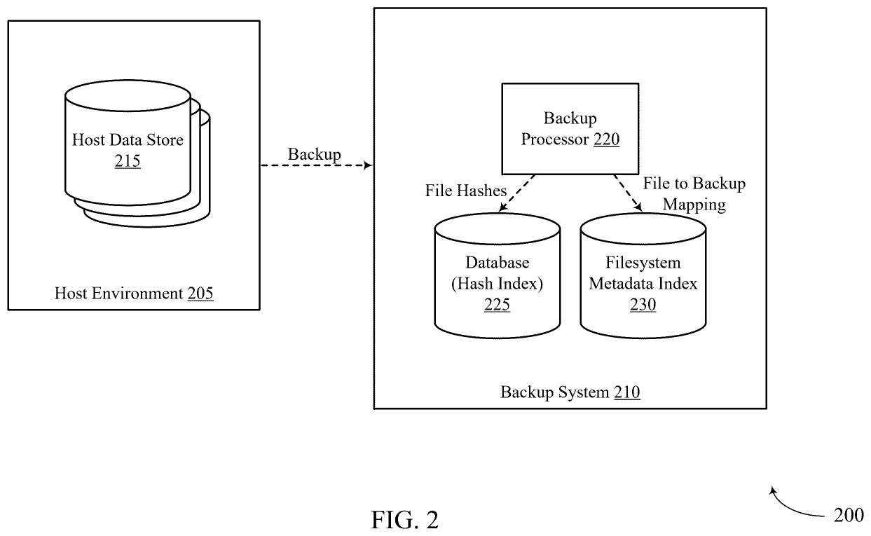

FIG. 2 shows an example of a computing environment 200 that supports precomputing file hashes for malware identification in accordance with aspects of the present disclosure. The computing environment 200 includes a host environment 205 and a backup system 210. The host environment 205 may be an example of the computing system 105 of FIG. 1, and the backup system 210 may be an example of the DMS 110 and/or the cloud environment 195 of FIG. 1. The host environment 205 and the backup system 210 are illustrated as being separate computing systems, but should be understood that facilitation of backup and recovery solutions (as performed by the backup system 210) may be performed on computing systems on which the host environment 205 is hosted.

The host environment 205 includes one or more host data stores (e.g., a host data store 215), each of which may be hosted on a set of physical and/or logically separate storage systems. The host data store 215 may store various file types including documents, executable files, image files, multimedia files, database files, web files, data files (e.g., comma separated values (CSV) files, JavaScript Object Notation (JSON) files), and/or archive files. The various files may be used for various purposes. Executable files may support various services in the host environment, and the services may be used by users, internal systems, etc.

The backup system 210 may obtain backups of the host data store 215 to support backup and recovery management. The backups may be full backups or incremental backups, and the backups may be obtained in accordance with a schedule (e.g., periodically based on a SLA), Full backups may contain a complete file set of the host data store 215, while incremental backups may include data associated with changed or added files of the host data store 215 (e.g., since a previous backup). The backups may be examples of immutable backups that are maintained over a time series in accordance with the SLA. Immutable backups may ensure data integrity and prevent tampering and may establish a reliable foundation for recovery operations. The backup system 210 may read the backup data from the host data store 215 or may communicate with the host environment 205 and/or the host data store 215 to facilitate generation of the backup by the host environment 205 and/or the host data store 215.

The backup system 210 may implement a backup processor 220 to support the techniques described herein. For example, the backup processor 220 may implement techniques to identify files to hash, hash the identified files, store information in relevant storage locations, perform threat identification techniques (e.g., querying and data retrieval), among other procedures. In some cases, for each backup received for host data stores at the host environment 205, the backup processor 220 may identify files in the backup and compute cryptographic hashes (e.g., MD5, SHA-1, SHA-256) for the identified files in the backup. The files that are hashed may be based on whether the files are potentially malicious. For example, executable files included in a backup may be identified for hashing. The backup processor 220 may identify executable files based on the file extensions, file metadata, etc. For example, files with the extensions “.exe” (Windows executable files), “.DMG” (Mac OS X Disk Image files), “.APK” (Android Package Files), are identified as executable file types (having the potential to be malicious). In some examples, the permissions or other information associated with files is used to identify whether a file is executable. In the case of Linux files, file permissions may be analyzed to determine whether a file is executable. It should be understood that other types of information may be used to identify whether a file is executable or otherwise has the potential to be malicious or harmful to a computer system.

The hash values resulting from hashing the files of the backup may serve as a digital fingerprint that uniquely identify the content and state of each file that is hashed. The hashes are stored in a database 225, which is managed or accessed by the backup system 210, in association with metadata such as backup timestamps, file path identifiers, file size, file creation and last modification dates. Additionally, the database 225 is configured for rapid query and comparison. For example, the database 225 includes one or more tables that are clustered on the file hash to allow efficient querying by the hash value. Clustering may allow the rows to be sorted by the corresponding file hash, such that a querying job does not scan the entire table, which results in provide querying efficiency. Additionally the database 225 may store file hashes for an organization across multiple workloads, where each data store, host environment 205 etc. corresponds to a workload. In some cases, bulk ingestion procedures may be used to ingest the file data into the table of the database 225. For example, the data that is to be ingested is encoded into Avro files, and a batch of Avro files is bulk loaded into the table (e.g., BigQuery table). The table my include information such as workload identifier (e.g., identifying system from which the corresponding file is obtained), a snapshot or backup identifier (e.g., identify the backup from which the corresponding file is obtained), a snapshot or backup creation time, a file path for the corresponding file, and the file hash value. Thus, the backup database 225 (e.g., a “pre-hash database”) stores cryptographic hashes calculated from backup data at different points in time, capturing unique signatures of commonly utilized malicious file types in backups.

As described herein, the backup may be an incremental backup that includes files that have been added or changed since a previous backup. As a result, the file hashes that are included in the database 225 are from backups from which the files were added changed. This technique results in a reduction in the size of the database 225, but may not allow the backup processor 220 to identify other backups (occurring after the backup from which the file is identified/hashed) that contain a target file. Thus, the backup system 210 may also maintain a filesystem metadata index 230 for each workload, and the filesystem metadata index may include a mapping of a file path to each unexpired snapshot the file is present in, along with other metadata (e.g., file modification time in each snapshot). The filesystem metadata index 230 may be used to identify in which backups a given file is present. When new backups (e.g., incremental and full) are obtained, the backup system 210 may update the database 225 and the filesystem metadata index 230 to ensure an accurate representation of backup data.

These various systems and components may be used to identify if and where a threat (e.g., a malicious file) is present in the host environment 205. The identification process may include providing or identifying one or more hash values that are based on known compromised files, whether the files are identified within the host environment 205 or via an external information source. In some examples, a user may provide a list of hash values for known malicious files. Additionally, the user may provide a list of clusters, accounts, etc. (e.g., workloads) to search for the hash values. The backup processor 220 may query the database 225 for the hashes, and the system may efficiently identify a nearest clean recovery point (e.g., the most recent backup state that predates the compromise). For example, the backup processor 220 may issue a query to the database 225 to obtain a list of snapshots and workloads containing the hash values based on the malicious files. As described herein, the database 225 includes hash values based on snapshots in which a particular file was added or changed. As such, the backup processor 220 may use the filesystem metadata index 230 to identify other backups which include the same version of the file containing the malicious content.

Thus, after identifying, using the database 225, a backup in which a malicious file was introduced (by querying for malicious file hash values), the backup processor 220 references the filesystem metadata index 230 using the version of the file that contains the malicious content to identify other backups containing the malicious file. That is, for a given file path of a workload (e.g., a file path containing the malicious content), the backup processor 220 may identify a change history for versions of the file. For each version of the file, the backup processor 220 may associate a start and end time for that version. For positive matches (e.g., file paths, workloads, matched backup times) obtained from the database 225, the backup processor 220 references the filesystem metadata and matched backup time to identify which version of the file positively matched the malicious file. Next, the backup processor 220 references the filesystem metadata index 230 to identify other backups that include the same version of the file using the version start and end time, and the snapshot time, and the initial snapshots and additional backup identifiers may be output. From this information, the backup processor 220 may identify a latest backup which does not contain the malicious file, which may be interpreted as the nearest clean recovery point.

Additionally, a recovery operation may include the backup system 210 recovering the host environment 205, the host data store 215, or both using the nearest clean recovery point identified using the techniques described herein. Additionally, or alternatively, backups that are identified as containing the malicious file may be subject to quarantine, which may prevent the backups from being fully or partially restored.

Thus, the database 225 employs efficient data structures that supports rapid lookup and retrieval. Hash tables or similar indexing mechanisms may support near-instantaneous querying of hundreds of thousands of backup entries. This scalability may support handling large volumes of backup data that may be included in enterprise environments, such as the host environment 205. Additionally, positive matches for malicious files may be low for an enterprise environment, while the quantity of scanned files may be in the order of billions. However, using the techniques described herein, the scanning may be performed in the order of seconds. Additionally, by automating and accelerating the recovery point identification process, the techniques may support minimization of downtime and operational impact during cyber incidents. Additionally, immutable backups and cryptographic hashing may ensure data integrity, preventing unauthorized alterations and maintaining the trustworthiness of recovery operations. Further, the system described herein is designed to scale with the growing volume of backup data to supporting enterprise-level environments.

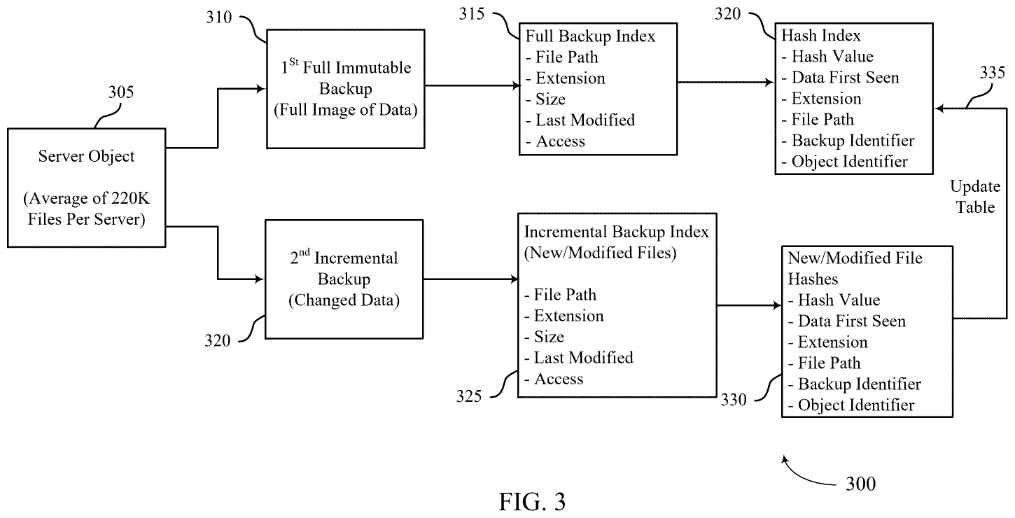

FIG. 3 shows an example of process flow 300 that supports precomputing file hashes for malware identification in accordance with aspects of the present disclosure. The process flow 300 includes example operations for generating and updating a hash index database, such as the database 225 as described with respect to FIG. 2, based on backup data.

The process flow includes a server object 305, which may be an example of a host data store 215 as described with respect to FIG. 2. In some examples, each server object is an example of a workload, server objects may contain an average of 220,000 files. However, other quantities of files are contemplated within the scope of the present disclosure. At 310, a first immutable backup (e.g., a full image of the server object 305) is obtained. That is, the backup system 210 of FIG. 2 may obtain the full image of the server object 305. At 315, the backup system may generate a backup index based on files included in the first immutable backup. As described herein, the backup system may select a subset of files for processing, such as files that deemed to be executable file types. Thus, the full backup index may be based on a subset of data included in the first full immutable backup. The full backup index may contain information for each file that is processed, such as the file path, the file extension, the file size, the last modified time, and access information. At 320, the backup system may generate or update a hash index (e.g., the database 225) based on the full backup index. The hash index table may contain a hash value for the file, the date/time when the file was first identified, the file extension, the file path, the backup identifier from which the file hash was generated, and the object identifier (e.g., identifier for the server object 305).

At 320, the backup system may obtain an incremental backup, which may include files that have been changed or added since the first immutable backup. At 325, the backup system may generate an incremental backup index based on identified files from the incremental backup. The incremental backup index may contain the same type of metadata that was included in the full backup index. At 330, the backup system may generate the file hashes based on the incremental backup index. At 335, the new or modified file hashes and the corresponding metadata is used to update the hash index database. Operations of the process flow 300 may be periodically performed based on obtaining new backups.

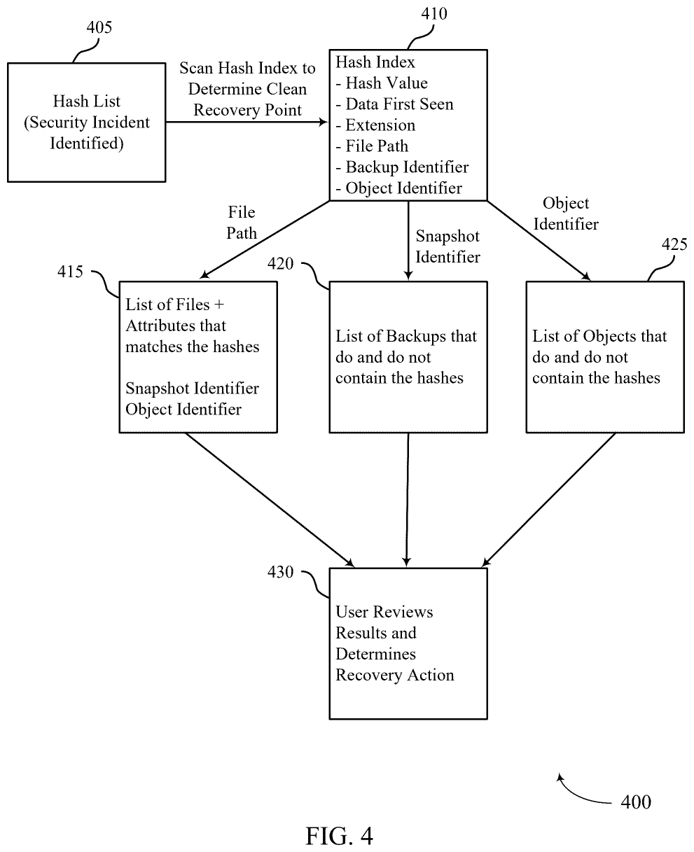

FIG. 4 shows an example of a process flow 400 that supports precomputing file hashes for malware identification in accordance with aspects of the present disclosure. The process flow 400 includes example operations for performing threat identification. For example, at 405, a backup system (e.g., backup system 210 of FIG. 2) may receive or obtain a hash list of one or more hash values associated with files deemed to have malicious content (e.g., indicators of compromise (IOCs)). At 410, the backup system may scan or query the hash index to identify backups that contain hash values included in the hash list. As a result, the backup system may identify file paths, snapshots, and objects that contain content from the hash list. As described herein, the hash index may contain hashes of files from backups where the files were added or modified. As such, the backup system may reference a filesystem metadata index (e.g., filesystem metadata index 230 of FIG. 2) to identify other backups containing the file with the same version of the files that have hash values matching the hash list.

Based on querying the hash index and referencing the file metadata indexes, the backup system may identify file paths, snapshot identifiers, and object identifiers. The file path may be associated with the list of files and file attributes that match the hashes in addition to the snapshot identifiers and object identifiers. At 420, the backup system may provide snapshot identifiers that contain and do not contain the files associated with the hash list. At 425, the backup system may provide the list of object identifiers that do and do not contain the files associated with the hash list. The list of files (and metadata), list of backup identifiers, and list of object identifiers may be provided to a user. Additionally, the information may be used to identify a nearest clean recovery point. At 430, a user may review the results and determine one or more recovery actions. Example recovery actions include quarantining backups with the matching hashes, recovering servers from backups not containing the matching hashes, and performing a safe recovery using backups containing the matching hashes for additional forensics and analysis.

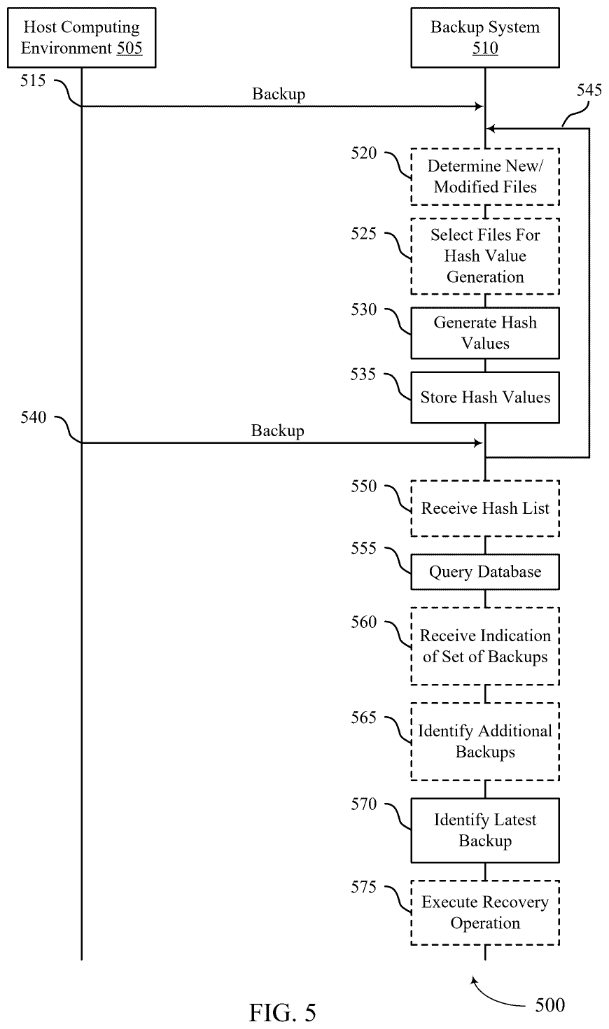

FIG. 5 shows an example of a process flow 500 that supports precomputing file hashes for malware identification in accordance with aspects of the present disclosure. The process flow 500 includes a host computing environment 505 and a backup system 510. The host computing environment 505 may be an example of the host environment 205 of FIG. 2 and may host objects (e.g., servers, host data stores) that are subject to backup as described herein with respect to FIGS. 1 through 4. Alternative examples of the following may be implemented, where some operations are performed in a different order than described or are not performed at all. In some cases, operations may include additional features not mentioned below, or further operations may be added. Although the host computing environment 505 and the backup system 510 are shown performing the operations of the process flow 300, some aspects of some operations may also be performed by one or more other components or systems.

At 515, the backup system 510 may obtain a first backup of a host data store in the host computing environment 505 and the first backup may contain (e.g., comprise, include, carry) a set of files from the host data store. Obtaining the backup may include reading the backup or reading the data from the host data store of the host computing environment 505. Additionally, or alternatively, obtaining the backup may include receiving the backup data from the host computing environment 505. In some cases, the backup system 510 may communicate with the host computing environment 505 to cause generation of the backup of the host data store. For example, the backup system 510 may transmit a request, to the host computing environment 505, and the request may cause the host computing environment 505 to generate the backup.

At 520, the backup system 510 may determine, using the first backup of the host data store, a subset of files of the plurality of files that are new or modified since a second backup of the host data store that is prior to the first backup. For example, the first backup may contain new or modified files (and not contain unmodified files) such that the backup system 510 determines the subset of files from the first backup. Additionally, or alternatively, the backup system determines the new or modified files by comparing the backup to data associated with the second backup.

At 525, the backup system 510 may select the one or more files for hash value generation from the subset of files that are new or modified since the second backup. Additionally, or alternatively, the backup system 510 may select the one or more files for hash value generation based at least in part on the one or more files being executable file types. The backup system 510 may identify the one or more files as the executable file types based at least in part on respective file extensions for the one or more files, respective permissions for the one or more files, or a combination thereof.

At 530, the backup system 510 may generate for the one or more files of the set of files, a respective hash value using content of a respective file of the one or more files. In some cases, generation of the has values includes generating a message-digest algorithm 5 (MD5) hash, a secure hash algorithm 1 (SHA-1) hash, a SHA-256 hash, a fuzzy hash, or a combination thereof.

At 535, the backup system 510 may store the respective hash value for the one or more files of the set of files in a database in association with metadata for the respective file. The database may be indexed based on hash values for files referenced in the database and wherein the metadata for the respective file is indicative of the first backup containing the respective file. In some examples, the database is configured such that rows of a data table containing hash values associated with files in the host data store are sorted based on the hash values, wherein the data table is queried for the hash value. Additionally, or alternatively, the database includes first hash values for a first set of files in the host data store that is a first host data store, and second hash values for a second set of files in a second host data store. Moreover, the first host data store is associated with a first workload identifier, the second host data store is associated with a second workload identifier, each first hash value for the first set of files is associated with the first workload identifier in the metadata for the first hash values in the database, and each second hash value for the second set of files is associated with the second workload identifier in the metadata for the second hash values in the database. In some examples, the metadata for the respective file comprises a workload identifier, a backup identifier, a backup creation time, a file path of the respective file, the respective hash value, a file size of the respective file, a file type of the respective file, a modification date of the respective file, or a combination thereof.

At 540, the backup system 510 may obtain another (e.g., a third) backup of the host data store in the host computing environment 505. In such cases, at 545 the backup system may repeat operations at 520 to 535.

At 550, the backup system 510 may receive a hash list that includes one or more hash values generated based on content of a compromised file. The hash list and/or the compromised file may be input and/or identified by a user, the backup system 510, or both. For example, the user may identify that a known file is compromised or receiving information associated with a compromised file from a third party. The hash list may be provided in accordance with a recovery operation at the backup system 510.

At 555, the backup system 510 may query in accordance with a recovery operation of the host environment, the database for at least one of the hash values generated based on content of a compromised file.

At 560, the backup system 510 may receive, in response to querying the database, an indication of a set of backups that contain the compromised file based on the hash value, where the set of backups is associated with the hash value in the database based on the compromised file being modified or introduced to the host data store in the host environment. In such cases, at 565, the backup system 510 may identify from a filesystem metadata index and using a version number of the compromised file as included in the set of backups, a set of additional backups that contain the compromised file with the version number. In such cases, the version number of the compromised file is associated with a file creation metadata, file modified metadata, file deleted date metadata, or some combination thereof. Moreover, the set of additional backups is identified based at least in part on the file creation metadata, file modified metadata, file deleted date metadata, or a combination thereof.

At 570, the backup system 510 may identify, in response to querying the database, a latest backup of the host data store of the host environment that does not contain the hash value for the compromised file. Identifying the latest backup may include identifying a set of backups that include the compromised file, and the latest backup is identified using the identified set of backups.

At 575, the backup system 510 may execute the recovery operation, which may include executing the recovery operation using the latest backup of the host data store of the host environment that does not contain the hash value for the compromised file, and execution of the recovery operation using the latest backup may result in recovery of the host data store at a state corresponding to the latest backup. In some examples, the backup system 510 may quarantine the backups that include the compromised file.

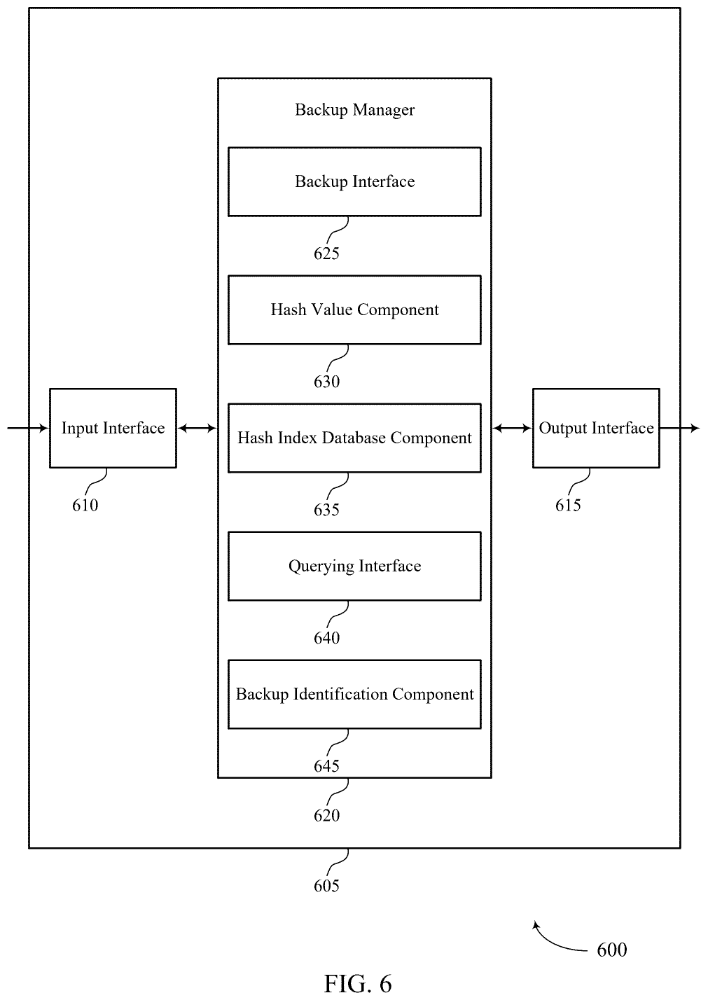

FIG. 6 shows a block diagram 600 of a system 605 that supports precomputing file hashes for malware identification in accordance with aspects of the present disclosure. In some examples, the system 605 may be an example of aspects of one or more components described with reference to FIG. 1, such as a DMS 110. The system 605 may include an input interface 610, an output interface 615, and a backup manager 620. The system 605 may also include one or more processors. Each of these components may be in communication with one another (e.g., via one or more buses, communications links, communications interfaces, or any combination thereof).

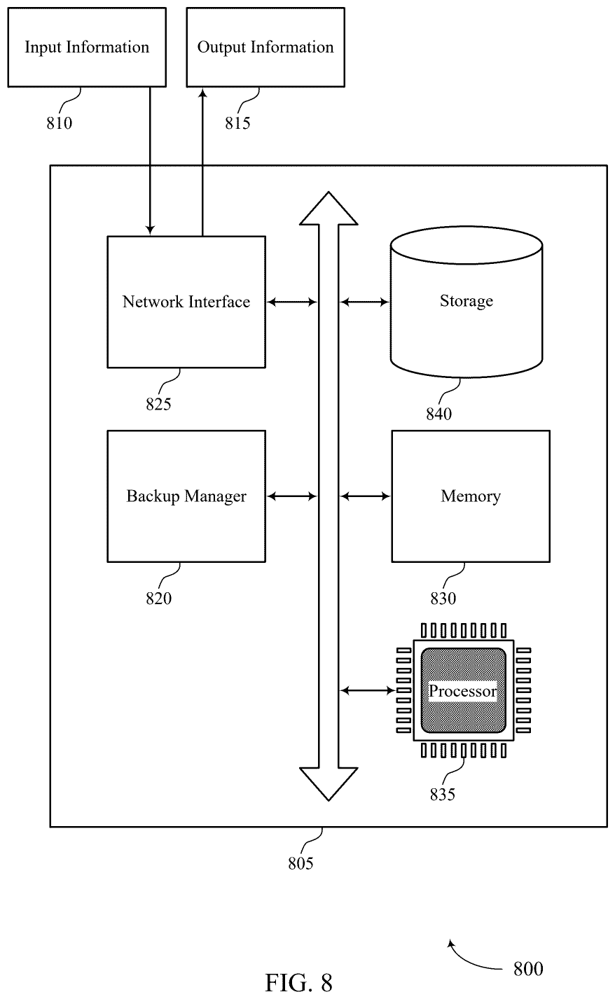

The input interface 610 may manage input signaling for the system 605. For example, the input interface 610 may receive input signaling (e.g., messages, packets, data, instructions, commands, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the backup manager 620 to support precomputing file hashes for malware identification. In some cases, the input interface 610 may be a component of a network interface 825 as described with reference to FIG. 8.

The output interface 615 may manage output signaling for the system 605. For example, the output interface 615 may receive signaling from other components of the system 605, such as the backup manager 620, and may transmit such output signaling corresponding to (e.g., representative of or otherwise based on) such signaling to other systems or devices. In some cases, the output interface 615 may be a component of a network interface 825 as described with reference to FIG. 8.

For example, the backup manager 620 may include a backup interface 625, a hash value component 630, a hash index database component 635, a querying interface 640, a backup identification component 645, or any combination thereof. In some examples, the backup manager 620, or various components thereof, may be configured to perform various operations (e.g., receiving, monitoring, transmitting) using or otherwise in cooperation with the input interface 610, the output interface 615, or both. For example, the backup manager 620 may receive information from the input interface 610, send information to the output interface 615, or be integrated in combination with the input interface 610, the output interface 615, or both to receive information, transmit information, or perform various other operations as described herein.

The backup interface 625 may be configured as or otherwise support a means for obtaining a first backup of a host data store in a host environment, the first backup containing a set of multiple files from the host data store. The hash value component 630 may be configured as or otherwise support a means for generating, for one or more files of the set of multiple files, a respective hash value using content of a respective file of the one or more files. The hash index database component 635 may be configured as or otherwise support a means for storing the respective hash value for the one or more files of the set of multiple files in a database in association with metadata for the respective file, where the database is indexed based on hash values for files referenced in the database and where the metadata for the respective file is indicative of the first backup containing the respective file. The querying interface 640 may be configured as or otherwise support a means for querying, in accordance with a recovery operation of the host environment, the database for a hash value generated based on content of a compromised file. The backup identification component 645 may be configured as or otherwise support a means for identifying, in response to querying the database, a latest backup of the host data store of the host environment that does not contain the hash value for the compromised file.

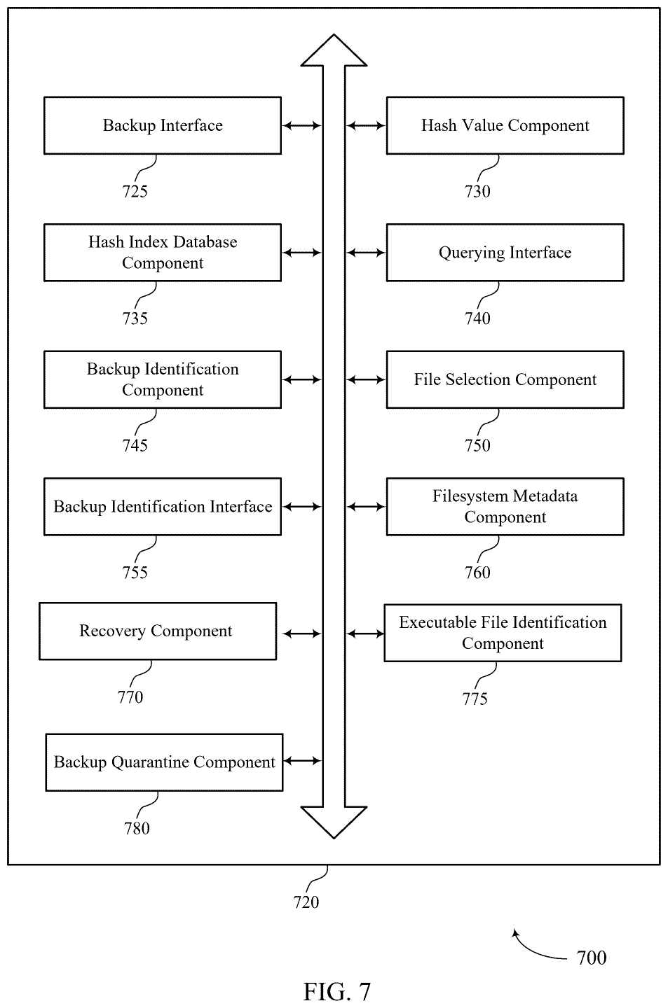

FIG. 7 shows a block diagram 700 of a backup manager 720 that supports precomputing file hashes for malware identification in accordance with aspects of the present disclosure. The backup manager 720 may be an example of aspects of a backup manager or a backup manager 620, or both, as described herein. The backup manager 720, or various components thereof, may be an example of means for performing various aspects of precomputing file hashes for malware identification as described herein. For example, the backup manager 720 may include a backup interface 725, a hash value component 730, a hash index database component 735, a querying interface 740, a backup identification component 745, a file selection component 750, a backup identification interface 755, a filesystem metadata component 760, a recovery component 770, an executable file identification component 775, a backup quarantine component 780, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The backup interface 725 may be configured as or otherwise support a means for obtaining a first backup of a host data store in a host environment, the first backup containing a set of multiple files from the host data store. The hash value component 730 may be configured as or otherwise support a means for generating, for one or more files of the set of multiple files, a respective hash value using content of a respective file of the one or more files. The hash index database component 735 may be configured as or otherwise support a means for storing the respective hash value for the one or more files of the set of multiple files in a database in association with metadata for the respective file, where the database is indexed based on hash values for files referenced in the database and where the metadata for the respective file is indicative of the first backup containing the respective file. The querying interface 740 may be configured as or otherwise support a means for querying, in accordance with a recovery operation of the host environment, the database for a hash value generated based on content of a compromised file. The backup identification component 745 may be configured as or otherwise support a means for identifying, in response to querying the database, a latest backup of the host data store of the host environment that does not contain the hash value for the compromised file.

In some examples, the file selection component 750 may be configured as or otherwise support a means for selecting the one or more files for hash value generation based on the one or more files being executable file types.

In some examples, the executable file identification component 775 may be configured as or otherwise support a means for identifying the one or more files as the executable file types based on respective file extensions for the one or more files, respective permissions for the one or more files, or a combination thereof.

In some examples, the file selection component 750 may be configured as or otherwise support a means for determining, using the first backup of the host data store, a subset of files of the set of multiple files that are new or modified since a second backup of the host data store that is prior to the first backup. In some examples, the file selection component 750 may be configured as or otherwise support a means for selecting the one or more files for hash value generation from the subset of files that are new or modified since the second backup.

In some examples, to support identifying the latest backup, the backup identification interface 755 may be configured as or otherwise support a means for receiving, in response to querying the database, an indication of a set of backups that contain the compromised file based on the hash value, where the set of backups is associated with the hash value in the database based on the compromised file being modified or introduced to the host data store in the host environment. In some examples, to support identifying the latest backup, the filesystem metadata component 760 may be configured as or otherwise support a means for identifying, from a filesystem metadata index and using a version number of the compromised file as included in the set of backups, a set of additional backups that contain the compromised file with the version number.

In some examples, the version number of the compromised file is associated with a file creation metadata, file modified metadata, file deleted date metadata. In some examples, the set of additional backups is identified based on the file creation metadata, file modified metadata, file deleted date metadata, or a combination thereof.

In some examples, to support identifying the latest backup, the backup identification component 745 may be configured as or otherwise support a means for identifying a set of backups that include the compromised file, where the latest backup is identified using the identified set of backups.

In some examples, the backup quarantine component 780 may be configured as or otherwise support a means for quarantining each backup of the set of backups in response to identifying the set of backups that include the compromised file.

In some examples, the hash index database component 735 may be configured as or otherwise support a means for configuring the database such that rows of a data table containing hash values associated with files in the host data store are sorted based on the hash values, where the data table is queried for the hash value.

In some examples, the database includes first hash values for a first set of files in the host data store that is a first host data store. In some examples, the database includes second hash values for a second set of files in a second host data store.

In some examples, the first host data store is associated with a first workload identifier. In some examples, the second host data store is associated with a second workload identifier. In some examples, each first hash value for the first set of files is associated with the first workload identifier in the metadata for the first hash values in the database. In some examples, each second hash value for the second set of files is associated with the second workload identifier in the metadata for the second hash values in the database.

In some examples, the metadata for the respective file includes a workload identifier, a backup identifier, a backup creation time, a file path of the respective file, the respective hash value, a file size of the respective file, a file type of the respective file, a modification date of the respective file, or a combination thereof.

In some examples, to support generating the respective hash value, the hash value component 730 may be configured as or otherwise support a means for generating a message-digest algorithm 5 (MD5) hash, a secure hash algorithm 1 (SHA-1) hash, a SHA-256 hash, a fuzzy hash, or a combination thereof.

In some examples, the recovery component 770 may be configured as or otherwise support a means for executing the recovery operation using the latest backup of the host data store of the host environment that does not contain the hash value for the compromised file, where execution of the recovery operation using the latest backup results in recovery of the host data store at a state corresponding to the latest backup.

FIG. 8 shows a block diagram 800 of a system 805 that supports precomputing file hashes for malware identification in accordance with aspects of the present disclosure. The system 805 may be an example of or include components of a system 605 as described herein. The system 805 may include components for data management, including components such as a backup manager 820, an input information 810, an output information 815, a network interface 825, at least one memory 830, at least one processor 835, and a storage 840. These components may be in electronic communication or otherwise coupled with each other (e.g., operatively, communicatively, functionally, electronically, electrically; via one or more buses, communications links, communications interfaces, or any combination thereof). Additionally, the components of the system 805 may include corresponding physical components or may be implemented as corresponding virtual components (e.g., components of one or more virtual machines). In some examples, the system 805 may be an example of aspects of one or more components described with reference to FIG. 1, such as a DMS 110.

The network interface 825 may enable the system 805 to exchange information (e.g., input information 810, output information 815, or both) with other systems or devices (not shown). For example, the network interface 825 may enable the system 805 to connect to a network (e.g., a network 120 as described herein). The network interface 825 may include one or more wireless network interfaces, one or more wired network interfaces, or any combination thereof. In some examples, the network interface 825 may be an example of may be an example of aspects of one or more components described with reference to FIG. 1, such as one or more network interfaces 165.

Memory 830 may include RAM, ROM, or both. The memory 830 may store computer-readable, computer-executable software including instructions that, when executed, cause the processor 835 to perform various functions described herein. In some cases, the memory 830 may contain, among other things, a basic input/output system (BIOS), which may control basic hardware or software operation such as the interaction with peripheral components or devices. In some cases, the memory 830 may be an example of aspects of one or more components described with reference to FIG. 1, such as one or more memories 175.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in a memory 830 to perform various functions (e.g., functions or tasks supporting precomputing file hashes for malware identification). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. In some cases, the processor 835 may be an example of aspects of one or more components described with reference to FIG. 1, such as one or more processors 170.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1, such as one or more network disks 180.

For example, the backup manager 820 may be configured as or otherwise support a means for obtaining a first backup of a host data store in a host environment, the first backup containing a set of multiple files from the host data store. The backup manager 820 may be configured as or otherwise support a means for generating, for one or more files of the set of multiple files, a respective hash value using content of a respective file of the one or more files. The backup manager 820 may be configured as or otherwise support a means for storing the respective hash value for the one or more files of the set of multiple files in a database in association with metadata for the respective file, where the database is indexed based on hash values for files referenced in the database and where the metadata for the respective file is indicative of the first backup containing the respective file. The backup manager 820 may be configured as or otherwise support a means for querying, in accordance with a recovery operation of the host environment, the database for a hash value generated based on content of a compromised file. The backup manager 820 may be configured as or otherwise support a means for identifying, in response to querying the database, a latest backup of the host data store of the host environment that does not contain the hash value for the compromised file.

By including or configuring the backup manager 820 in accordance with examples as described herein, the system 805 may support techniques for precomputing file hashes for malware identification, which may provide one or more benefits such as, for example, more efficient (e.g., improved processor and memory efficiency) identification of malware by precomputing hash values and storing the hash values in a database that is indexed based on the hash values, among other possibilities.

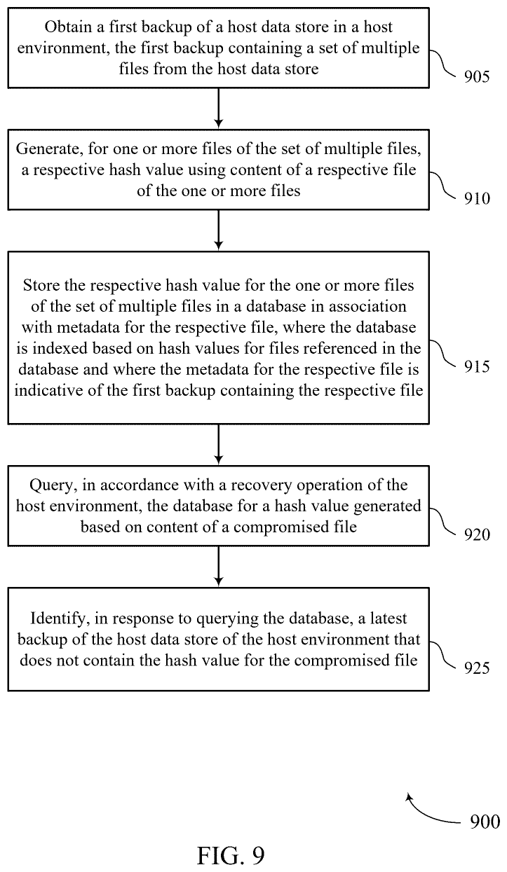

FIG. 9 shows a flowchart illustrating a method 900 that supports precomputing file hashes for malware identification in accordance with aspects of the present disclosure. The operations of the method 900 may be implemented by a DMS or its components as described herein. For example, the operations of the method 900 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 905, the method may include obtaining a first backup of a host data store in a host environment, the first backup containing a set of multiple files from the host data store. The operations of 905 may be performed in accordance with examples as disclosed herein. In some examples, aspects of the operations of 905 may be performed by a backup interface 725 as described with reference to FIG. 7.

At 910, the method may include generating, for one or more files of the set of multiple files, a respective hash value using content of a respective file of the one or more files. The operations of 910 may be performed in accordance with examples as disclosed herein. In some examples, aspects of the operations of 910 may be performed by a hash value component 730 as described with reference to FIG. 7.

At 915, the method may include storing the respective hash value for the one or more files of the set of multiple files in a database in association with metadata for the respective file, where the database is indexed based on hash values for files referenced in the database and where the metadata for the respective file is indicative of the first backup containing the respective file. The operations of 915 may be performed in accordance with examples as disclosed herein. In some examples, aspects of the operations of 915 may be performed by a hash index database component 735 as described with reference to FIG. 7.

At 920, the method may include querying, in accordance with a recovery operation of the host environment, the database for a hash value generated based on content of a compromised file. The operations of 920 may be performed in accordance with examples as disclosed herein. In some examples, aspects of the operations of 920 may be performed by a querying interface 740 as described with reference to FIG. 7.

At 925, the method may include identifying, in response to querying the database, a latest backup of the host data store of the host environment that does not contain the hash value for the compromised file. The operations of 925 may be performed in accordance with examples as disclosed herein. In some examples, aspects of the operations of 925 may be performed by a backup identification component 745 as described with reference to FIG. 7.

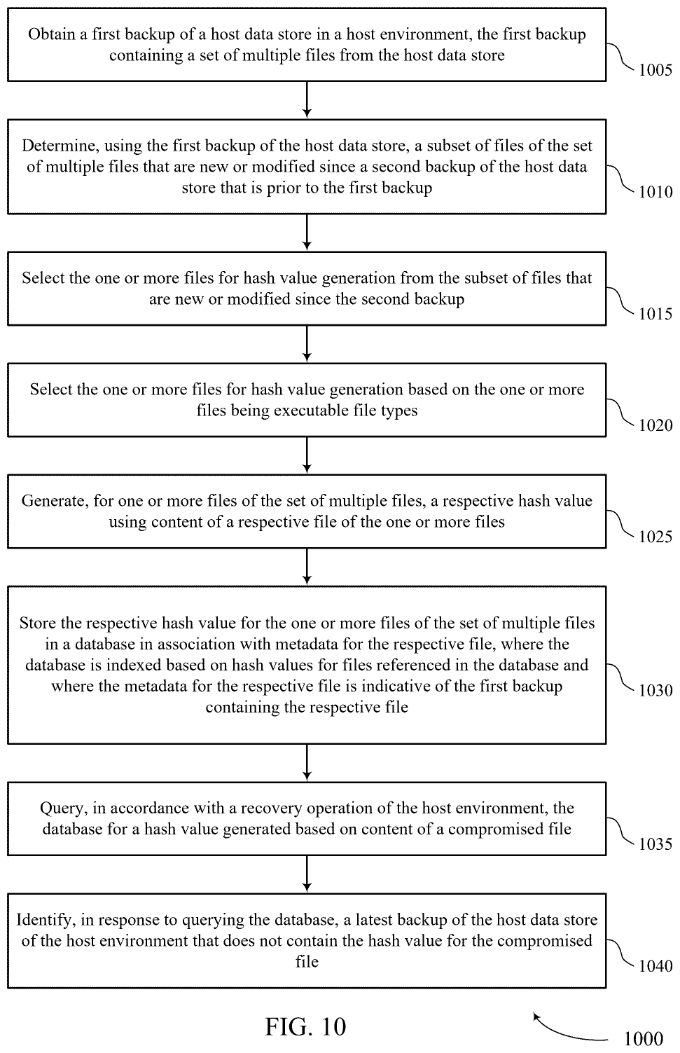

FIG. 10 shows a flowchart illustrating a method 1000 that supports precomputing file hashes for malware identification in accordance with aspects of the present disclosure. The operations of the method 1000 may be implemented by a DMS or its components as described herein. For example, the operations of the method 1000 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 1005, the method may include obtaining a first backup of a host data store in a host environment, the first backup containing a set of multiple files from the host data store. The operations of 1005 may be performed in accordance with examples as disclosed herein. In some examples, aspects of the operations of 1005 may be performed by a backup interface 725 as described with reference to FIG. 7.

At 1010, the method may include determining, using the first backup of the host data store, a subset of files of the set of multiple files that are new or modified since a second backup of the host data store that is prior to the first backup. The operations of 1010 may be performed in accordance with examples as disclosed herein. In some examples, aspects of the operations of 1010 may be performed by a file selection component 750 as described with reference to FIG. 7.

At 1015, the method may include selecting the one or more files for hash value generation from the subset of files that are new or modified since the second backup. The operations of 1015 may be performed in accordance with examples as disclosed herein. In some examples, aspects of the operations of 1015 may be performed by a file selection component 750 as described with reference to FIG. 7.

At 1020, the method may include selecting the one or more files for hash value generation based on the one or more files being executable file types. The operations of 1020 may be performed in accordance with examples as disclosed herein. In some examples, aspects of the operations of 1020 may be performed by a file selection component 750 as described with reference to FIG. 7.

At 1025, the method may include generating, for one or more files of the set of multiple files, a respective hash value using content of a respective file of the one or more files. The operations of 1025 may be performed in accordance with examples as disclosed herein. In some examples, aspects of the operations of 1025 may be performed by a hash value component 730 as described with reference to FIG. 7.

At 1030, the method may include storing the respective hash value for the one or more files of the set of multiple files in a database in association with metadata for the respective file, where the database is indexed based on hash values for files referenced in the database and where the metadata for the respective file is indicative of the first backup containing the respective file. The operations of 1030 may be performed in accordance with examples as disclosed herein. In some examples, aspects of the operations of 1030 may be performed by a hash index database component 735 as described with reference to FIG. 7.

At 1035, the method may include querying, in accordance with a recovery operation of the host environment, the database for a hash value generated based on content of a compromised file. The operations of 1035 may be performed in accordance with examples as disclosed herein. In some examples, aspects of the operations of 1035 may be performed by a querying interface 740 as described with reference to FIG. 7.

At 1040, the method may include identifying, in response to querying the database, a latest backup of the host data store of the host environment that does not contain the hash value for the compromised file. The operations of 1040 may be performed in accordance with examples as disclosed herein. In some examples, aspects of the operations of 1040 may be performed by a backup identification component 745 as described with reference to FIG. 7.

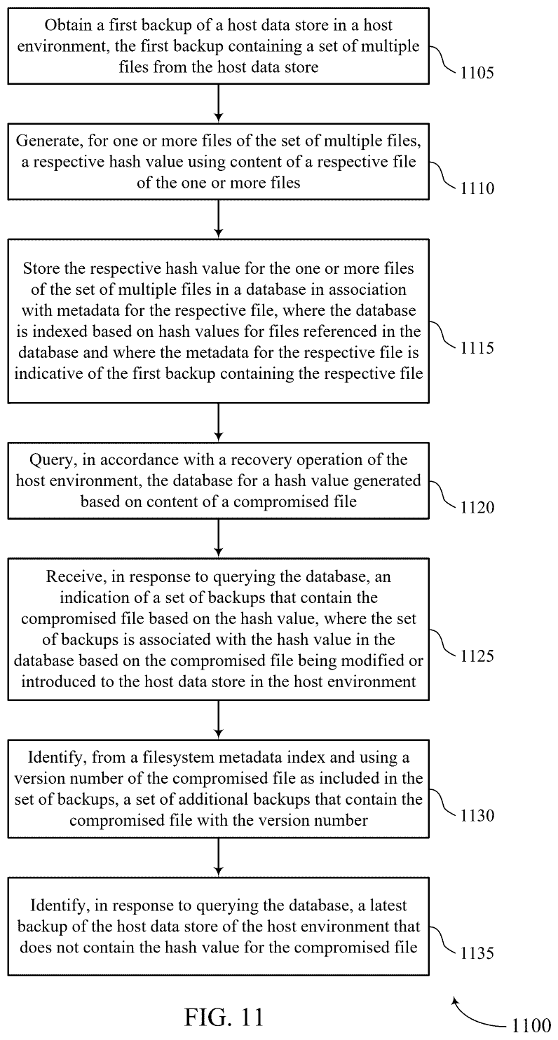

FIG. 11 shows a flowchart illustrating a method 1100 that supports precomputing file hashes for malware identification in accordance with aspects of the present disclosure. The operations of the method 1100 may be implemented by a DMS or its components as described herein. For example, the operations of the method 1100 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 1105, the method may include obtaining a first backup of a host data store in a host environment, the first backup containing a set of multiple files from the host data store. The operations of 1105 may be performed in accordance with examples as disclosed herein. In some examples, aspects of the operations of 1105 may be performed by a backup interface 725 as described with reference to FIG. 7.

At 1110, the method may include generating, for one or more files of the set of multiple files, a respective hash value using content of a respective file of the one or more files. The operations of 1110 may be performed in accordance with examples as disclosed herein. In some examples, aspects of the operations of 1110 may be performed by a hash value component 730 as described with reference to FIG. 7.

At 1115, the method may include storing the respective hash value for the one or more files of the set of multiple files in a database in association with metadata for the respective file, where the database is indexed based on hash values for files referenced in the database and where the metadata for the respective file is indicative of the first backup containing the respective file. The operations of 1115 may be performed in accordance with examples as disclosed herein. In some examples, aspects of the operations of 1115 may be performed by a hash index database component 735 as described with reference to FIG. 7.

At 1120, the method may include querying, in accordance with a recovery operation of the host environment, the database for a hash value generated based on content of a compromised file. The operations of 1120 may be performed in accordance with examples as disclosed herein. In some examples, aspects of the operations of 1120 may be performed by a querying interface 740 as described with reference to FIG. 7.

At 1125, the method may include receiving, in response to querying the database, an indication of a set of backups that contain the compromised file based on the hash value, where the set of backups is associated with the hash value in the database based on the compromised file being modified or introduced to the host data store in the host environment. The operations of 1125 may be performed in accordance with examples as disclosed herein. In some examples, aspects of the operations of 1125 may be performed by a backup identification interface 755 as described with reference to FIG. 7.

At 1130, the method may include identifying, from a filesystem metadata index and using a version number of the compromised file as included in the set of backups, a set of additional backups that contain the compromised file with the version number. The operations of 1130 may be performed in accordance with examples as disclosed herein. In some examples, aspects of the operations of 1130 may be performed by a filesystem metadata component 760 as described with reference to FIG. 7.

At 1135, the method may include identifying, in response to querying the database, a latest backup of the host data store of the host environment that does not contain the hash value for the compromised file. The operations of 1135 may be performed in accordance with examples as disclosed herein. In some examples, aspects of the operations of 1135 may be performed by a backup identification component 745 as described with reference to FIG. 7.

A method by an apparatus is described. The method may include obtaining a first backup of a host data store in a host environment, the first backup containing a set of multiple files from the host data store, generating, for one or more files of the set of multiple files, a respective hash value using content of a respective file of the one or more files, storing the respective hash value for the one or more files of the set of multiple files in a database in association with metadata for the respective file, where the database is indexed based on hash values for files referenced in the database and where the metadata for the respective file is indicative of the first backup containing the respective file, querying, in accordance with a recovery operation of the host environment, the database for a hash value generated based on content of a compromised file, and identifying, in response to querying the database, a latest backup of the host data store of the host environment that does not contain the hash value for the compromised file.

An apparatus is described. The apparatus may include one or more memories storing processor executable code, and one or more processors coupled with the one or more memories. The one or more processors may individually or collectively be operable to execute the code to cause the apparatus to obtain a first backup of a host data store in a host environment, the first backup containing a set of multiple files from the host data store, generate, for one or more files of the set of multiple files, a respective hash value using content of a respective file of the one or more files, store the respective hash value for the one or more files of the set of multiple files in a database in association with metadata for the respective file, where the database is indexed based on hash values for files referenced in the database and where the metadata for the respective file is indicative of the first backup containing the respective file, query, in accordance with a recovery operation of the host environment, the database for a hash value generated based on content of a compromised file, and identify, in response to querying the database, a latest backup of the host data store of the host environment that does not contain the hash value for the compromised file.

Another apparatus is described. The apparatus may include means for obtaining a first backup of a host data store in a host environment, the first backup containing a set of multiple files from the host data store, means for generating, for one or more files of the set of multiple files, a respective hash value using content of a respective file of the one or more files, means for storing the respective hash value for the one or more files of the set of multiple files in a database in association with metadata for the respective file, where the database is indexed based on hash values for files referenced in the database and where the metadata for the respective file is indicative of the first backup containing the respective file, means for querying, in accordance with a recovery operation of the host environment, the database for a hash value generated based on content of a compromised file, and means for identifying, in response to querying the database, a latest backup of the host data store of the host environment that does not contain the hash value for the compromised file.

A non-transitory computer-readable medium storing code is described. The code may include instructions executable by one or more processors to obtain a first backup of a host data store in a host environment, the first backup containing a set of multiple files from the host data store, generate, for one or more files of the set of multiple files, a respective hash value using content of a respective file of the one or more files, store the respective hash value for the one or more files of the set of multiple files in a database in association with metadata for the respective file, where the database is indexed based on hash values for files referenced in the database and where the metadata for the respective file is indicative of the first backup containing the respective file, query, in accordance with a recovery operation of the host environment, the database for a hash value generated based on content of a compromised file, and identify, in response to querying the database, a latest backup of the host data store of the host environment that does not contain the hash value for the compromised file.

Some examples of the method, apparatus, and non-transitory computer-readable medium described herein may further include operations, features, means, or instructions for selecting the one or more files for hash value generation based on the one or more files being executable file types.

Some examples of the method, apparatus, and non-transitory computer-readable medium described herein may further include operations, features, means, or instructions for identifying the one or more files as the executable file types based on respective file extensions for the one or more files, respective permissions for the one or more files, or a combination thereof.

Some examples of the method, apparatus, and non-transitory computer-readable medium described herein may further include operations, features, means, or instructions for determining, using the first backup of the host data store, a subset of files of the set of multiple files that may be new or modified since a second backup of the host data store that may be prior to the first backup and selecting the one or more files for hash value generation from the subset of files that may be new or modified since the second backup.

In some examples of the method, apparatus, and non-transitory computer-readable medium described herein, identifying the latest backup may include operations, features, means, or instructions for receiving, in response to querying the database, an indication of a set of backups that contain the compromised file based on the hash value, where the set of backups may be associated with the hash value in the database based on the compromised file being modified or introduced to the host data store in the host environment and identifying, from a filesystem metadata index and using a version number of the compromised file as included in the set of backups, a set of additional backups that contain the compromised file with the version number.

In some examples of the method, apparatus, and non-transitory computer-readable medium described herein, the version number of the compromised file may be associated with a file creation metadata, file modified metadata, file deleted date metadata and the set of additional backups may be identified based on the file creation metadata, file modified metadata, file deleted date metadata, or a combination thereof.

In some examples of the method, apparatus, and non-transitory computer-readable medium described herein, identifying the latest backup may include operations, features, means, or instructions for identifying a set of backups that include the compromised file, where the latest backup may be identified using the identified set of backups.

Some examples of the method, apparatus, and non-transitory computer-readable medium described herein may further include operations, features, means, or instructions for quarantining each backup of the set of backups in response to identifying the set of backups that include the compromised file.

Some examples of the method, apparatus, and non-transitory computer-readable medium described herein may further include operations, features, means, or instructions for configuring the database such that rows of a data table containing hash values associated with files in the host data store may be sorted based on the hash values, where the data table may be queried for the hash value.

In some examples of the method, apparatus, and non-transitory computer-readable medium described herein, the database includes first hash values for a first set of files in the host data store that may be a first host data store and the database includes second hash values for a second set of files in a second host data store.

In some examples of the method, apparatus, and non-transitory computer-readable medium described herein, the first host data store may be associated with a first workload identifier, the second host data store may be associated with a second workload identifier, each first hash value for the first set of files may be associated with the first workload identifier in the metadata for the first hash values in the database, and each second hash value for the second set of files may be associated with the second workload identifier in the metadata for the second hash values in the database.

In some examples of the method, apparatus, and non-transitory computer-readable medium described herein, the metadata for the respective file includes a workload identifier, a backup identifier, a backup creation time, a file path of the respective file, the respective hash value, a file size of the respective file, a file type of the respective file, a modification date of the respective file, or a combination thereof.

In some examples of the method, apparatus, and non-transitory computer-readable medium described herein, generating the respective hash value may include operations, features, means, or instructions for generating a message-digest algorithm 5 (MD5) hash, a secure hash algorithm 1 (SHA-1) hash, a SHA-256 hash, a fuzzy hash, or a combination thereof.

Some examples of the method, apparatus, and non-transitory computer-readable medium described herein may further include operations, features, means, or instructions for executing the recovery operation using the latest backup of the host data store of the host environment that does not contain the hash value for the compromised file, where execution of the recovery operation using the latest backup results in recovery of the host data store at a state corresponding to the latest backup.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
obtaining a first backup of a host data store in a host environment, the first backup containing a plurality of files from the host data store;
generating, for one or more files of the plurality of files, a respective hash value using content of a respective file of the one or more files;
storing the respective hash value for the one or more files of the plurality of files in a database in association with metadata for the respective file, wherein the database is indexed based on hash values for files referenced in the database and wherein the metadata for the respective file is indicative of the first backup containing the respective file;
querying, in accordance with a recovery operation of the host environment, the database for a hash value generated based on content of a compromised file; and
identifying, in response to querying the database, a latest backup of the host data store of the host environment that does not contain the hash value for the compromised file.

2. The method of claim 1, further comprising:
selecting the one or more files for hash value generation based at least in part on the one or more files being executable file types.

3. The method of claim 2, further comprising:
identifying the one or more files as the executable file types based at least in part on respective file extensions for the one or more files, respective permissions for the one or more files, or a combination thereof.

4. The method of claim 1, further comprising:
determining, using the first backup of the host data store, a subset of files of the plurality of files that are new or modified since a second backup of the host data store that is prior to the first backup; and
selecting the one or more files for hash value generation from the subset of files that are new or modified since the second backup.

5. The method of claim 1, wherein identifying the latest backup comprises:
receiving, in response to querying the database, an indication of a set of backups that contain the compromised file based on the hash value, wherein the set of backups is associated with the hash value in the database based at least in part on the compromised file being modified or introduced to the host data store in the host environment; and
identifying, from a filesystem metadata index and using a version number of the compromised file as included in the set of backups, a set of additional backups that contain the compromised file with the version number.

6. The method of claim 5, wherein:
the version number of the compromised file is associated with a file creation metadata, file modified metadata, file deleted date metadata, and
the set of additional backups is identified based at least in part on the file creation metadata, file modified metadata, file deleted date metadata, or a combination thereof.

7. The method of claim 1, wherein identifying the latest backup comprises:
identifying a set of backups that include the compromised file, wherein the latest backup is identified using the identified set of backups.

8. The method of claim 7, further comprising:
quarantining each backup of the set of backups in response to identifying the set of backups that include the compromised file.

9. The method of claim 1, further comprising:
configuring the database such that rows of a data table containing hash values associated with files in the host data store are sorted based on the hash values, wherein the data table is queried for the hash value.

10. The method of claim 1, wherein:
the database comprises first hash values for a first set of files in the host data store that is a first host data store; and
the database comprises second hash values for a second set of files in a second host data store.

11. The method of claim 10, wherein:
the first host data store is associated with a first workload identifier;
the second host data store is associated with a second workload identifier;
each first hash value for the first set of files is associated with the first workload identifier in the metadata for the first hash values in the database; and
each second hash value for the second set of files is associated with the second workload identifier in the metadata for the second hash values in the database.

12. The method of claim 1, wherein the metadata for the respective file comprises a workload identifier, a backup identifier, a backup creation time, a file path of the respective file, the respective hash value, a file size of the respective file, a file type of the respective file, a modification date of the respective file, or a combination thereof.

13. The method of claim 1, wherein generating the respective hash value comprises:
generating a message-digest algorithm 5 (MD5) hash, a secure hash algorithm (SHA-1) hash, a SHA-256 hash, a fuzzy hash, or a combination thereof.

14. The method of claim 1, further comprising:
executing the recovery operation using the latest backup of the host data store of the host environment that does not contain the hash value for the compromised file, wherein execution of the recovery operation using the latest backup results in recovery of the host data store at a state corresponding to the latest backup.

15. An apparatus, comprising:
one or more memories storing processor-executable code; and
one or more processors coupled with the one or more memories and individually or collectively operable to execute the code to cause the apparatus to:
obtain a first backup of a host data store in a host environment, the first backup containing a plurality of files from the host data store;
generate, for one or more files of the plurality of files, a respective hash value using content of a respective file of the one or more files;
store the respective hash value for the one or more files of the plurality of files in a database in association with metadata for the respective file, wherein the database is indexed based on hash values for files referenced in the database and wherein the metadata for the respective file is indicative of the first backup containing the respective file;
query, in accordance with a recovery operation of the host environment, the database for a hash value generated based on content of a compromised file; and
identify, in response to querying the database, a latest backup of the host data store of the host environment that does not contain the hash value for the compromised file.

16. The apparatus of claim 15, wherein the one or more processors are individually or collectively further operable to execute the code to cause the apparatus to:
select the one or more files for hash value generation based at least in part on the one or more files being executable file types.

17. The apparatus of claim 16, wherein the one or more processors are individually or collectively further operable to execute the code to cause the apparatus to:
identify the one or more files as the executable file types based at least in part on respective file extensions for the one or more files, respective permissions for the one or more files, or a combination thereof.

18. A non-transitory computer-readable medium storing code, the code comprising instructions executable by one or more processors to:
obtain a first backup of a host data store in a host environment, the first backup containing a plurality of files from the host data store;
generate, for one or more files of the plurality of files, a respective hash value using content of a respective file of the one or more files;
store the respective hash value for the one or more files of the plurality of files in a database in association with metadata for the respective file, wherein the database is indexed based on hash values for files referenced in the database and wherein the metadata for the respective file is indicative of the first backup containing the respective file;
query, in accordance with a recovery operation of the host environment, the database for a hash value generated based on content of a compromised file; and
identify, in response to querying the database, a latest backup of the host data store of the host environment that does not contain the hash value for the compromised file.

19. The non-transitory computer-readable medium of claim 18, wherein the instructions are further executable by the one or more processors to:
select the one or more files for hash value generation based at least in part on the one or more files being executable file types.

20. The non-transitory computer-readable medium of claim 19, wherein the instructions are further executable by the one or more processors to:
identify the one or more files as the executable file types based at least in part on respective file extensions for the one or more files, respective permissions for the one or more files, or a combination thereof.
